(19) United States
(12) Patent Application Publication
(10) Pub. No.: US 2002/0082034 A1
(43) Pub. Date: Jun. 27, 2002

(54) Mobile radio terminal apparatus and data transfer method

(76) Inventor: Shinichiro Suzuki, Hachioji-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/951,757

(22) Filed: Sep. 14, 2001

(30) Foreign Application Priority Data
Dec. 22, 2000 (JP) 2000-391305
Mar. 30, 2001 (JP) 2001-101858

(51) Int. Cl. H04B 7/00

(52) U.S. Cl. 455/517; 455/509

(57) ABSTRACT

A transmissible capacity acquisition section extracts receivable capacity from a reception signal received from a base station. An actual transmission capacity determination section determines an actual transmission capacity on the basis of the receivable capacity and the data transmission speed between the base station and the other communication party. The actual transmission capacity indicates a transmission capacity for communication, with which the average speed of communication between a communication terminal and the base station does not exceed the data transmission speed. A transmission data flow control section controls communication with the communication terminal via a transmission/reception control section on the basis of the actual transmission capacity and the capacity of data to be transmitted to the base station, thereby preventing time-out of the communication terminal.

### CROSS-REFERENCE TO RELATED APPLICATIONS

This application is based upon and claims the benefit of priority from the prior Japanese Patent Applications No. 2000-391305, filed Dec. 22, 2000; and No. 2001-101858, filed Mar. 30, 2001, the entire contents of both of which are incorporated herein by reference.

### BACKGROUND OF THE INVENTION

1. Field of the Invention

The present invention relates to a mobile radio terminal apparatus that can transmit data input from communication terminals such as a personal computer, a PDA (Personal Digital Assistance) terminal, and a portable facsimile.

2. Description of the Related Art

As is well known, a conventional mobile radio terminal apparatus of a mobile communication system has an interface connectable to such communication terminals as a personal computer, a PDA (Personal Digital Assistance) terminal, a portable facsimile, etc. The mobile radio terminal apparatus can function to transmit data, which has been input from these devices, over a radio line.

FIG. 7 shows an example of data communication using a conventional mobile radio terminal apparatus, wherein the above-mentioned communication terminal is connected to the mobile radio terminal apparatus to transmit facsimile data.

In FIG. 7, facsimile data from the communication terminal is once stored in the mobile radio terminal apparatus, and then the facsimile data is sent to a base station over a radio link, and finally it reaches a facsimile terminal via a public network.

The speed of data transmission between the communication terminal and the mobile radio terminal apparatus is higher than that of data transmission between the base station and the facsimile via the public network.

In order not to overflow of data on the base station side, the base station informs a receivable data amount to the mobile radio terminal apparatus and the mobile radio terminal apparatus controls the data transmission to the base station on the basis of the receivable data amount.

In the conventional mobile radio terminal apparatus, the data transmission to the base station is controlled in this manner to prevent overflow of data on the base station side. However, if much time is consumed for the data transmission to the base station owing to this control, time-out will occur in the communication terminal that has completed transmission of a predetermined amount of data to the mobile radio terminal apparatus and that stays in the standby state. As a result, the communication terminal will cease the communication.

### BRIEF SUMMARY OF THE INVENTION

The present invention has been made in consideration of the above problem, and its object is to provide a mobile radio terminal apparatus and a data transfer method, which can prevent suspension of communication by a communication terminal and can ensure exact and smooth data transmission, even when much time has been consumed for data transmission with a base station.

In order to achieve the object, the invention of claim 1 provides a mobile radio terminal apparatus comprising: first communication means for communication with a communication terminal capable of transmitting data; data storage means for temporarily storing the data received from the communication terminal via the first communication means; second communication means for radio communication with a base station connectable to a communication network; detection means for detecting receivable capacity information indicative of a receivable data capacity of the base station, on the basis of a signal received from the base station via the second communication means; and control means for controlling the first communication means, thereby controlling data reception from the communication terminal, on the basis of the receivable capacity information detected by the detection means and a communication speed on the communication network.

In the mobile radio terminal apparatus according to the present invention, the data reception from the communication terminal is controlled based on the receivable capacity information detected by the detection means and the communication speed on the communication network.

Thus, according to the mobile radio terminal apparatus with the above structure, even when much time has been consumed for data transmission between the base station and the other communication party via the communication network, the data reception from the communication terminal can be controlled. Therefore, it is possible to prevent time-out of the communication terminal during the data transmission from the communication terminal to the mobile radio terminal apparatus, and ensuring smooth data transmission.

In order to achieve the above object, the invention of claim 4 provides a data transfer method for radio-communicating with a base station connectable to a communication network and transferring data received from a communication terminal capable of transmitting data to the communication network by means of the radio communication, the method comprising: a data storing step of temporarily storing the data received from the communication terminal; a capacity receiving step of receiving, from the base station, receivable capacity information indicative of a receivable data capacity of the base station; and reception control step of controlling data reception from the communication terminal on the basis of the receivable capacity information received in the capacity receiving step and a communication speed on the communication network.

In the data transfer method with the above constitution, the data reception from the communication terminal is controlled based on the receivable capacity information received in the capacity receiving step and the communication speed on the communication network.

Thus, according to the data transfer method with the above constitution, even when much time has been consumed for data transmission between the base station and the other communication party via the communication network, the data reception from the communication terminal can be controlled. Therefore, it is possible to prevent time-out of the communication terminal during the data transmission from the communication terminal to the apparatus adopting this data transfer method, and ensuring smooth data transmission.

In order to achieve the above object, the invention of claim 7 provides a mobile radio terminal apparatus comprising: first communication means for communication with a communication terminal capable of transmitting data; data storage means for temporarily storing the data received from the communication terminal via the first communication means; second communication means for radio communication with a base station connectable to a communication network; detection means for detecting receivable capacity information indicative of a receivable data capacity of the base station, on the basis of a signal received from the base station via the second communication means; reception control means for controlling the first communication means, thereby controlling data reception from the communication terminal, on the basis of the receivable capacity information detected by the detection means and a communication speed on the communication network; and detection control means for controlling the detection means prior to the control of the reception control means and detecting new receivable capacity information.

According to the mobile radio terminal apparatus with this structure, the detection means detects the receivable capacity information prior to the control of data reception from the communication terminal, and the data reception from the communication terminal is controlled based on the receivable capacity information and the communication speed on the communication network.

Thus, according to the mobile radio terminal apparatus with this structure, the determination as to the data reception can be effected in a more suitable manner for the actual situation, and more exact data transmission can be performed. Even when much time has been consumed for data transmission between the base station and the other communication party via the communication network, the data reception from the communication terminal can be controlled. Therefore, it is possible to prevent time-out of the communication terminal during the data transmission from the communication terminal to the mobile radio terminal apparatus, and ensuring smooth data transmission.

In order to achieve the above object, the invention of claim 10 provides a data transfer method for radio-communicating with a base station connectable to a communication network and transferring data received from a communication terminal capable of transmitting data to the communication network by means of the radio communication, the method comprising: a data storing step of temporarily storing the data received from the communication terminal; a capacity receiving step of receiving, from the base station, receivable capacity information indicative of a receivable data capacity of the base station; a reception control step of controlling data reception from the communication terminal on the basis of the receivable capacity information received in the capacity receiving step and a communication speed on the communication network; and a detection control step of executing the capacity receiving step prior to the reception control step and detecting new receivable capacity information.

In the data transfer method with the above constitution, the receivable capacity information is detected prior to the control of data reception from the communication terminal, and the data reception from the communication terminal is controlled based on the receivable capacity information received in the capacity receiving step and the communication speed on the communication network.

Thus, according to the data transfer method with the above constitution, the determination as to the data reception can be effected in a more suitable manner for the actual situation, and more exact data transmission can be performed. Even when much time has been consumed for data transmission between the base station and the other communication party via the communication network, the data reception from the communication terminal can be controlled. Therefore, it is possible to prevent time-out of the communication terminal during the data transmission from the communication terminal to the apparatus adopting this data transfer method, and ensuring smooth data transmission.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a circuit block diagram showing the structure of a mobile radio terminal apparatus according to a first embodiment of the present invention;

FIG. 2 is a flow chart illustrating a communication control operation of the mobile radio terminal apparatus shown in FIG. 1;

FIG. 3 is a flow chart illustrating a communication control operation of the mobile radio terminal apparatus shown in FIG. 1;

FIG. 4 is a circuit block diagram showing the structure of a mobile radio terminal apparatus according to a second embodiment of the present invention;

FIG. 5 is a flow chart illustrating a communication control operation of the mobile radio terminal apparatus shown in FIG. 4;

FIG. 6 is a flow chart illustrating a communication control operation of the mobile radio terminal apparatus shown in FIG. 4; and

FIG. 7 shows a data transmission system using a mobile radio terminal apparatus.

### DETAILED DESCRIPTION OF THE INVENTION

A first embodiment of the present invention will now be described.

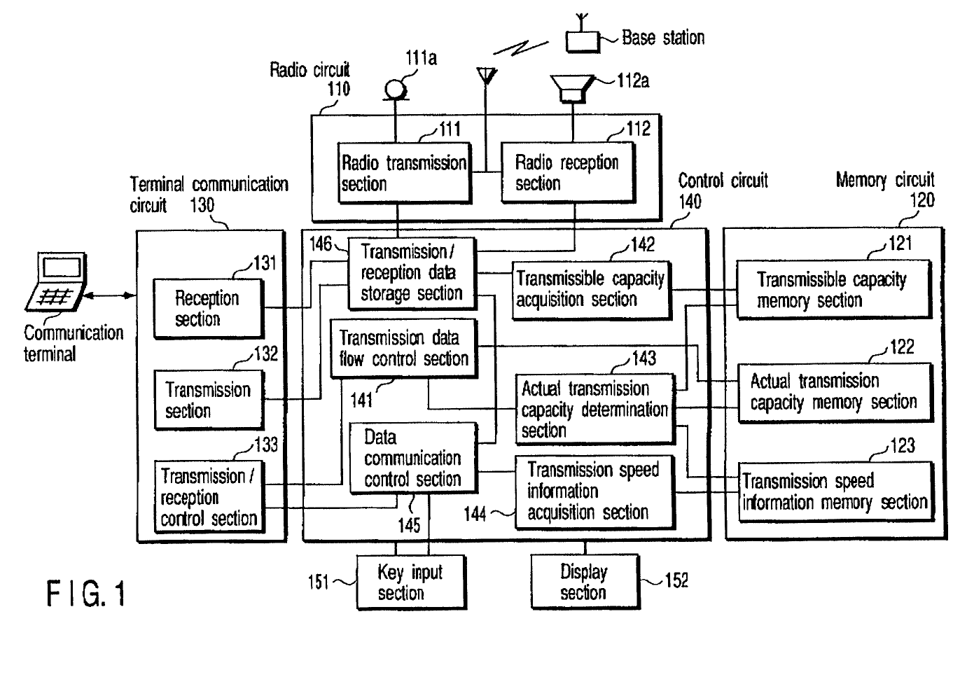

FIG. 1 shows the structure of a mobile radio terminal apparatus according to the first embodiment of the present invention. The mobile radio terminal apparatus comprises a radio circuit 110, a memory circuit 120, a terminal communication circuit 130 and a control circuit 140.

The radio circuit 110 comprises a radio transmission section 111 for modulating voice input from a microphone 111a and transmitting the modulated voice as a radio signal to a base station; and a radio reception section 112 for receiving a radio signal from the base station, demodulating the received signal, and outputting the demodulated voice from a loudspeaker 112a.

The memory circuit 120 stores various data in a non-volatile memory, a volatile memory, etc. Specifically, the memory circuit 120 stores various setting information necessary for communication via the base station, and user-set data such as telephone directory data.

The memory circuit 120 stores a transmissible capacity memory section 121, an actual transmission capacity memory section 122 and a transmission speed information memory section 123.

The transmissible capacity memory section 121 stores a value of a receivable capacity reported from the base station.

The actual transmission capacity memory section 122 stores data on an actual transmission capacity determined by an actual transmission capacity determination section 143 (to be described later).

The transmission speed information memory section 123 stores data on the speed of data transmission between the base station and a communication terminal that is on the other party of communication.

The terminal communication circuit 130 comprises a reception section 131 for receiving data from the communication terminal, a transmission section 132 for transmitting data to the communication terminal, and a transmission/reception control section 133 for controlling the reception section 131 and transmission section 132.

The control circuit 140 comprises, for example, a microcomputer as a main control unit. The control circuit 140 controls the respective elements of the mobile radio terminal apparatus. Specifically, the control circuit 140 executes a series of controls of the mobile communication terminal relating to initial settings, call transmission/reception and calls of the mobile communication terminal, an input control by means of various keys of a key input section 151, and a display control of a display 152.

The control circuit 140 comprises a transmission data flow control section 141, a transmissible capacity acquisition section 142, an actual transmission capacity determination section 143, a transmission speed information acquisition section 144, a data communication control section 145, and a transmission/reception data storage section 146.

The transmissible capacity acquisition section 142 extracts information on a receivable capacity from a reception signal received from the base station, and records the information in the transmissible capacity memory section 121 as a transmissible capacity acquired from the base station.

The transmission speed information acquisition section 144 records information on the speed of data transmission between the base station and the other communication party in the transmission speed information memory section 123. This information on the data transmission speed is preset by the data communication control section 145 via the key input section 151, via the reception section 131 from the communication terminal, or via the radio reception section 112 from the base station.

The actual transmission capacity determination section 143 determines an actual transmission capacity on the basis of the transmissible capacity stored in the transmissible capacity memory section 121 and the data transmission speed stored in the transmission speed information memory section 123. The actual transmission capacity is indicative of a transmission capacity for communication, with which the average speed of communication between the communication terminal and the base station does not exceed the above-mentioned data transmission speed. The actual transmission capacity determination section 143 records the actual transmission capacity in the actual transmission capacity memory section 122.

The transmission data flow control section 141 controls data reception by the reception section 131 from the communication terminal by instructing reception permission/prohibition to the transmission/reception control section 133 on the basis of the actual transmission capacity stored in the actual transmission capacity memory section 122 and the capacity of data to be transmitted to the base station.

The data communication control section 145 executes communication controls such as a communication start and a communication end, on the basis of signals from the transmission/reception control section 133, key input section 151 and radio reception section 112.

The transmission/reception data storage section 146 temporarily stores data received from the communication terminal via the reception section 131, and data received from the base station via the radio reception section 112.

The operation of the mobile radio terminal apparatus with the above structure will now be described. Assume that a personal computer as a communication terminal is connected to the terminal communication circuit 130. In this operation, application software for facsimile transmission is executed on the personal computer to transmit facsimile data to a facsimile connected to a public network.

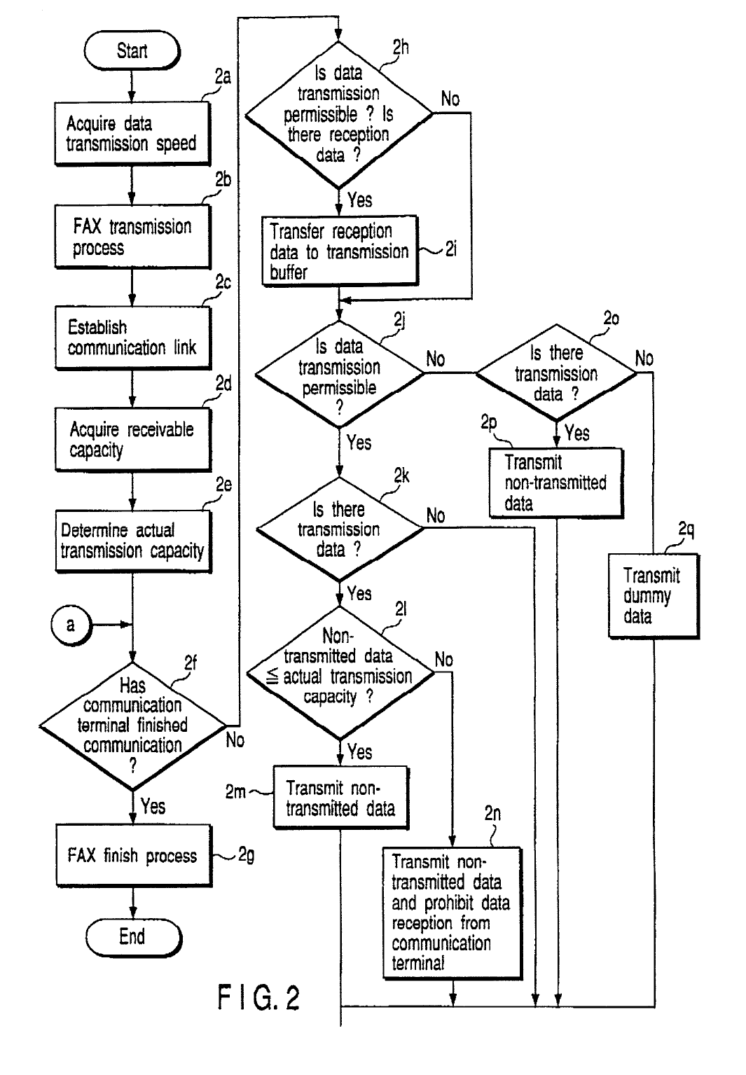

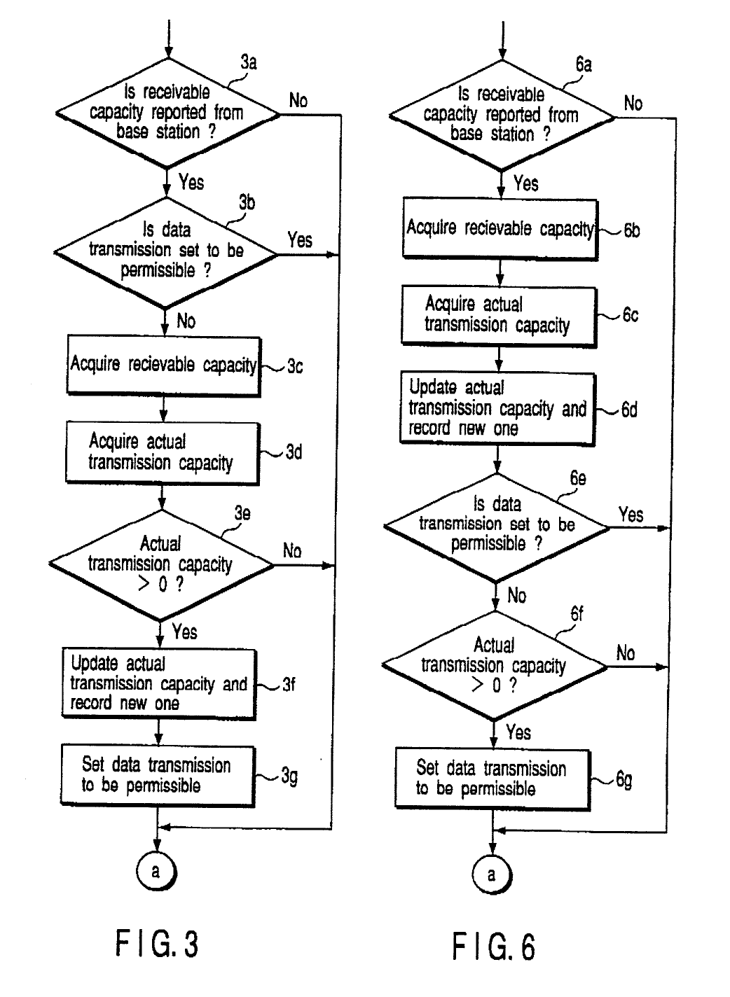

FIGS. 2 and 3 are flow charts illustrating the operation, and the process in the flow charts is executed by the control circuit 140.

The user activates the application software on the personal computer and starts facsimile data transmission. If a signal requesting facsimile data transmission is input from the personal computer, the transmission speed information acquisition section 144 acquires information on the speed of data transmission between the base station and the other communication party and records this information in the transmission speed information memory section 123 (step 2a). This information on the data transmission speed is preset by the data communication control section 145 via the key input section 151, via the reception section 131 from the communication terminal, or via the radio reception section 112 from the base station. The control goes to step 2b.

In step 2b, the data communication control section 145 reads the data transmission speed set in step 2a out of the transmission speed information memory section 123 via the transmission speed information acquisition section 144. Based on the data transmission speed, a facsimile data transmission process is started, and a radio communication link is established between the radio circuit 110 and the base station. The control then goes to step 2c.

In step 2c, a data communication link with the base station is established via the radio communication link established in step 2b.

In step 2d, the transmissible capacity acquisition section 142 acquires a value of a receivable capacity from a reception signal received by the radio reception section 112 from the base station, and records the value in the transmissible capacity memory section 121 as a transmissible capacity. The control goes to step 2e.

In step 2e, the actual transmission capacity determination section 143 determines an actual transmission capacity on the basis of the transmissible capacity stored in the transmissible capacity memory section 121 and the data transmission speed stored in the transmission speed information memory section 123. The actual transmission capacity is indicative of a transmission capacity for communication, with which the average speed of communication between the communication terminal and the base station does not exceed the above-mentioned data transmission speed. The actual transmission capacity determination section 143 records the actual transmission capacity in the actual transmission capacity memory section 122.

The transmission/reception control section 133 controls the reception section 131 and transmission section 132 to start reception of facsimile data from the personal computer. Thus, the control advances to step 2f.

In step 2f, the data communication control section 145 determines whether a facsimile transmission end signal has been received from the personal computer via the reception section 131, or from the key input section 151, or from the base station via the radio reception section 112.

If the data communication control section 145 determines that the facsimile transmission end signal has been received, a predetermined finish process is executed (step 2g) between the radio transmission section 111 and radio reception section 112, on the one hand, and the facsimiles on the other. Thus, the communication link is disconnected and the facsimile transmission is finished.

On the other hand, if the data communication control section 145 determines that the facsimile transmission end signal has not been received, the control goes to step 2h.

In step 2h, it is determined whether the transmission data flow control section 141 has issued a data transmission permission instruction to the transmission/reception control section 133 and the facsimile data received from the personal computer is stored in a reception buffer of the reception section 131.

If it has been determined in step 2h that the transmission data flow control section 141 has issued a data transmission permission instruction to the transmission/reception control section 133 and the facsimile data received from the personal computer is stored in a reception buffer of the reception section 131, the control advances to step 2i. Otherwise, the control advances to step 2j.

In step 2i, the facsimile data in the reception buffer of the reception section 131 is transferred to a transmission buffer of the transmission/reception data storage section 146, and the control goes to step 2j.

In step 2j, it is determined whether the transmission data flow control section 141 has issued the data transmission permission instruction to the transmission/reception control section 133.

In step 2j, if the transmission data flow control section 141 has issued the data transmission permission instruction to the transmission/reception control section 133, the control goes to step 2k. If the transmission data flow control section 141 has not issued the data transmission permission instruction to the transmission/reception control section 133, the control goes to step 2o.

In step 2k, the transmission data flow control section 141 determines whether the transmission buffer in the transmission/reception data storage section 146 contains facsimile data which has not yet been transmitted.

If the transmission data flow control section 141 has determined that the transmission buffer in the transmission/reception data storage section 146 contains non-transmitted facsimile data, the control goes to step 21. Otherwise, the control goes to step 3a.

In step 21, the actual transmission capacity determination section 143 compares the amount of non-transmitted facsimile data in the transmission buffer of the transmission/reception data storage section 146 with the actual transmission capacity stored in the actual transmission capacity memory section 122, and determines whether the amount of non-transmitted facsimile data is not greater than the actual transmission capacity.

If the actual transmission capacity determination section 143 determines that the amount of non-transmitted facsimile data is not greater than the actual transmission capacity, the control advances to step 2m. on the other hand, if the actual transmission capacity determination section 143 determines that the amount of non-transmitted facsimile data is greater than the actual transmission capacity, the control advances to step 2n.

In step 2m, the data communication control section 145 starts a process to transmit the non-transmitted facsimile data in the transmission buffer of the transmission/reception data storage section 146 to the facsimile from the radio transmission section 111 via the base station. The control then goes to step 3a.

In step 2n, the transmission data flow control section 141 issues a data transmission prohibition instruction to the transmission/reception control section 133. Thereby, the transmission/reception control section 133 informs the personal computer of prohibition of facsimile data transmission and stops reception of facsimile data at the reception section 131. Thus, the control goes to step 3a.

On the other hand, in step 2o, the transmission data flow control section 141 determines whether the transmission buffer in the transmission/reception data storage section 146 contains facsimile data which has not yet boon transmitted.

If the transmission data flow control section 141 has determined that the transmission buffer in the transmission/reception data storage section 146 contains non-transmitted facsimile data, the control goes to step 2p. Otherwise, the control goes to step 2q.

In step 2p, the data communication control section 145 starts a process to transmit the non-transmitted facsimile data in the transmission buffer of the transmission/reception data storage section 146 to the facsimile from the radio transmission section 111 via the base station. The control then goes to step 3a.

In step 2q, in order to acquire information indicative of a receivable capacity from the base station via the radio reception section 112, the data communication control section 145 issues to the radio transmission section 111 an instruction to transmit dummy data containing no facsimile data. Accepting the instruction, the radio transmission section 111 transmits the dummy data to the base station, and the control goes to step 3a.

In step 3a, the transmissible capacity acquisition section 142 monitors the reception signal received by the radio reception section 112, and determines whether data indicative of the receivable capacity has been received from the base station.

If the transmissible capacity acquisition section 142 has determined that the data indicative of the receivable capacity was received, the control advances to step 3b. If the transmissible capacity acquisition section 142 has determined that the data indicative of the receivable capacity was not received, the control advances to step 2f.

In step 3b, it is determined whether the transmission data flow control section 141 has issued a data transmission permission instruction to the transmission/reception control section 133.

If it is determined that the transmission data flow control section 141 has issued the data transmission permission instruction to the transmission/reception control section 133, the control goes to step 2f. On the other hand, if it is determined that the transmission data flow control section 141 has issued a data transmission prohibition instruction to the transmission/reception control section 133, the control goes to step 3c.

In step 3c, the transmissible capacity acquisition section 142 acquires a value of the receivable capacity from the reception signal received by the radio reception section 112 from the base station, and records the value in the transmissible capacity memory section 121 as a transmissible capacity. The control goes to step 3d.

In step 3d, in order to update the actual transmission capacity, the actual transmission capacity determination section 143 determines an actual transmission capacity on the basis of the transmissible capacity stored in the transmissible capacity memory section 121 and the data transmission speed stored in the transmission speed information memory section 123. The actual transmission capacity is indicative of a transmission capacity for communication, with which the average speed of communication between the communication terminal and the base station does not exceed the above-mentioned data transmission speed. The control then advances to step 3e.

In step 3e, the actual transmission capacity determination section 143 determines whether the value of the actual transmission capacity newly found in step 3d is greater than 0, that is, whether the transmission of facsimile data can be transmitted to the base station.

If the actual transmission capacity determination section 143 has determined that the value of the actual transmission capacity newly found in step 3d is greater than 0, the control goes to step 3f. If the value of the actual transmission capacity is not greater than 0, the control goes to step 2f.

In step 3f, the actual transmission capacity determination section 143 updates the actual transmission capacity in the actual transmission capacity memory section 122 and records therein the actual transmission capacity newly found in step 3d. The control advances to step 3g.

In step 3g the transmission data flow control section 141 issues a data transmission permission instruction to the transmission/reception control section 133, and the control goes to step 2f.

As has been described above, in the mobile radio terminal apparatus with the above structure, an actual transmission capacity is determined on the basis of the receivable capacity acquired from the base station and the data transmission speed indicative of the communication speed on the network. The actual transmission capacity is indicative of a transmission capacity for communication from the mobile radio terminal apparatus to the base station, with which the average speed of communication between the communication terminal (personal computer) and the base station via the mobile radio terminal apparatus does not exceed the above-mentioned data transmission speed.

This actual transmission capacity is compared with the amount of data (facsimile data) that has not yet been transmitted and remains in the mobile radio terminal apparatus. If the amount of data is greater than the actual transmission capacity, the data input from the communication terminal is limited.

In short, the input of data from the communication terminal is controlled based on the receivable capacity reported from the base station and the data transmission speed indicative of the communication speed on the network.

According to the mobile radio terminal apparatus with the above structure, even if a data transmission control is effected between the mobile radio terminal apparatus and the base station in order to prevent overflow of data on the base station side, the reception of data from the communication terminal can be controlled so as to prevent time-out of the communication terminal. Therefore, even when much time has been consumed for data transmission with the base station, it is possible to prevent suspension of communication by the communication terminal and ensure smooth data transmission.

A second embodiment of the present invention will now be described.

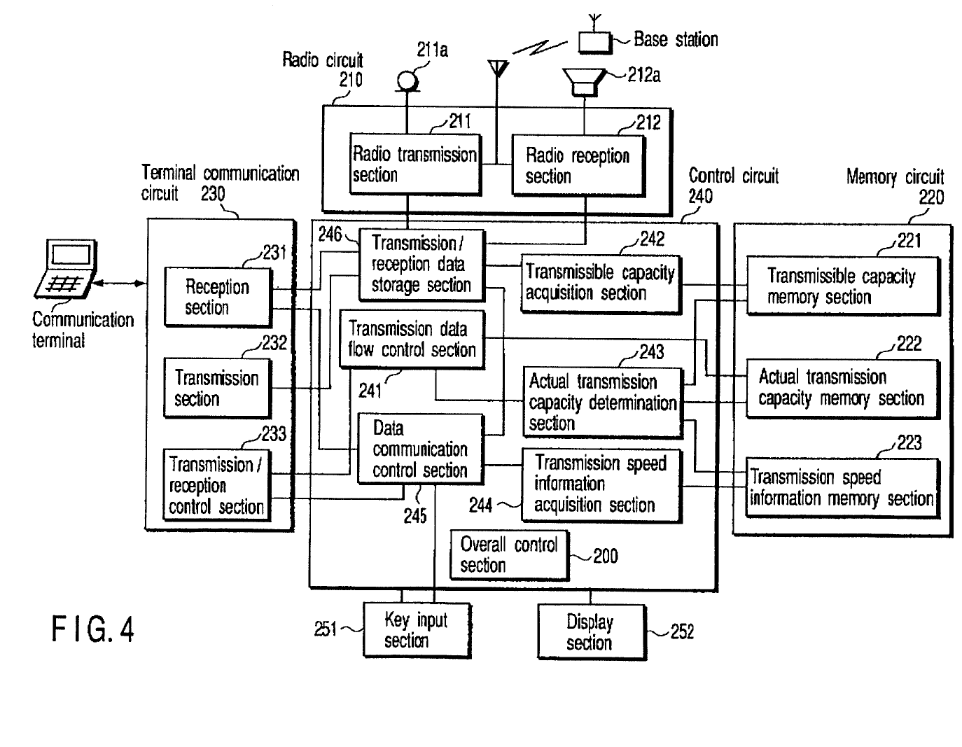

FIG. 4 shows the structure of a mobile radio terminal apparatus according to the second embodiment of the present invention. The mobile radio terminal apparatus comprises a radio circuit 210, a memory circuit 220, a terminal communication circuit 230 and a control circuit 240.

The radio circuit 210 comprises a radio transmission section 211 for modulating voice input from a microphone 211a and transmitting the modulated voice as a radio signal to a base station; and a radio reception section 212 for receiving a radio signal from the base station, demodulating the received signal, and outputting the demodulated voice from a loudspeaker 212a.

The memory circuit 220 saves various data in a non-volatile memory, a volatile memory, etc. Specifically, the memory circuit 220 stores various setting information necessary for communication via the base station, and user-set data such as telephone directory data,

The memory circuit 220 comprises a transmissible capacity memory section 221, an actual transmission capacity memory section 222 and a transmission speed information memory section 223.

The transmissible capacity memory section 221 stores a value of a receivable capacity reported from the base station.

The actual transmission capacity memory section 222 stores data on an actual transmission capacity determined by an actual transmission capacity determination section 243 (to be described later).

The transmission speed information memory section 223 stores data on the speed of data transmission between the base station and a communication terminal that is on the other party of communication.

The terminal communication circuit 230 comprises a reception section 231 for receiving data from the communication terminal, a transmission section 232 for transmitting data to the communication terminal, and a transmission/reception control section 233 for controlling the reception section 231 and transmission section 232.

The control circuit 240 comprises, for example, a microcomputer as a main control unit. The control circuit 240 controls the respective elements of the mobile radio terminal apparatus. Specifically, the control circuit 240 executes a series of controls of the mobile communication terminal relating to initial settings, call transmission/reception and calls of the mobile communication terminal, an input control by means of various keys of a key input section 251, and a display control of a display 252.

The control circuit 240 comprises a transmission data flow control section 241, a transmissible capacity acquisition section 242, an actual transmission capacity determination section 243, a transmission speed information acquisition section 244, a data communication control section 245, a transmission/reception data storage section 246, and an overall control section 200.

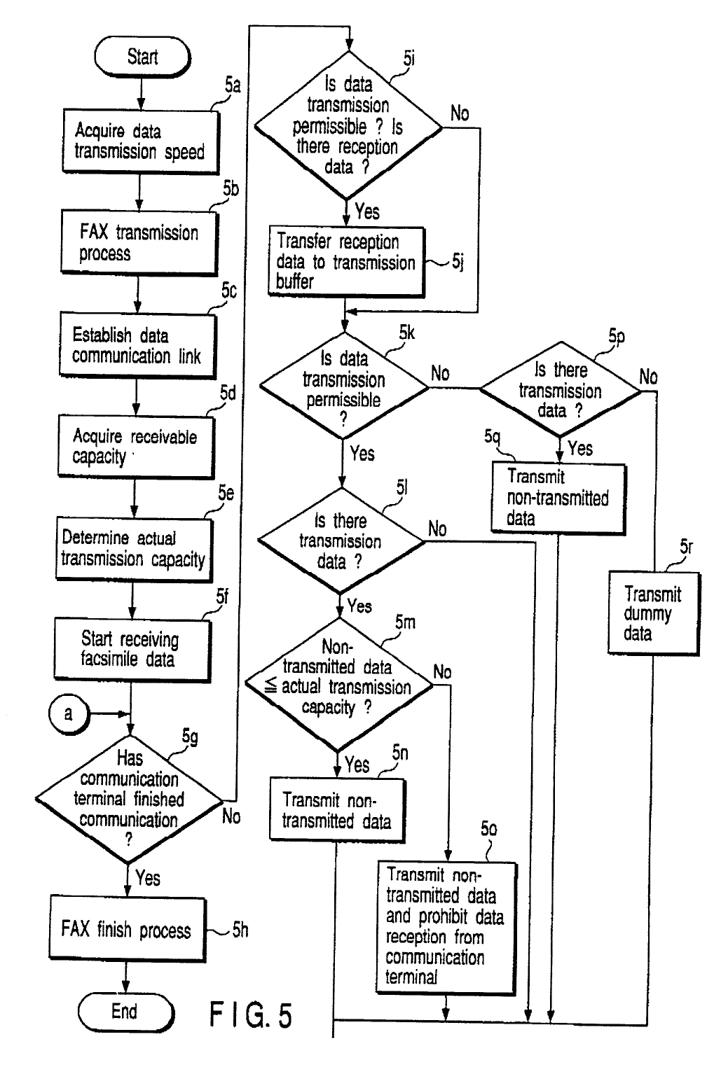

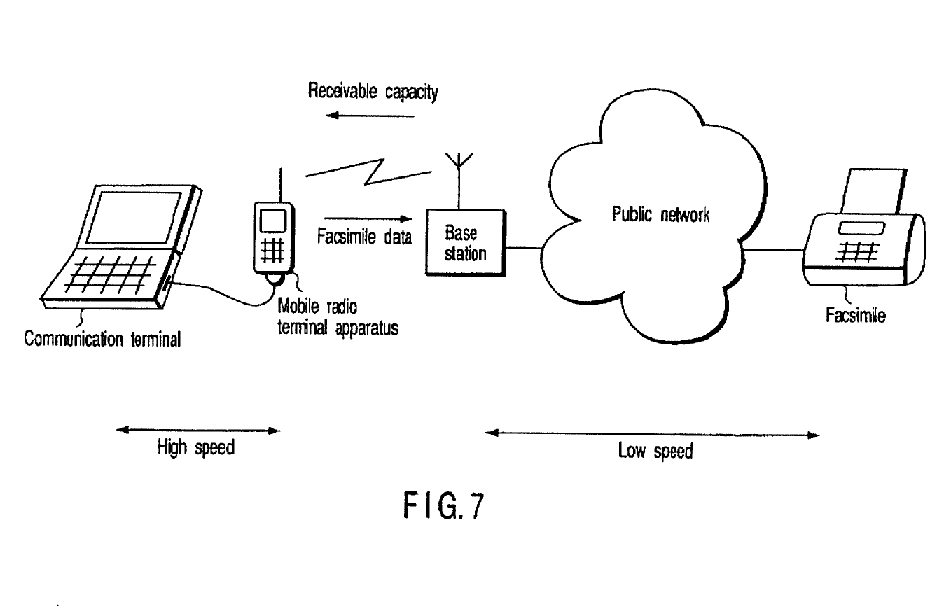

By the control of the overall control section 200, the respective elements of the control circuit 240 can function according to procedures shown in FIGS. 5 and 6, as will be described later.

The transmissible capacity acquisition section 242 extracts information on a receivable capacity from a reception signal received from the base station, and records the information in the transmissible capacity memory section 221 as a transmissible capacity acquired from the base station.

The transmission speed information acquisition section 244 records information on the speed of data transmission between the base station and the other communication party in the transmission speed information memory section 223. This information on the data transmission speed is preset by the data communication control section 245 via the key input section 251, via the reception section 231 from the communication terminal, or via the radio reception section 212 from the base station.

The actual transmission capacity determination section 243 determines an actual transmission capacity on the basis of the transmissible capacity stored in the transmissible capacity memory section 221 and the data transmission speed stored in the transmission speed information memory section 223. The actual transmission capacity is indicative of a transmission capacity for communication, with which the average speed of communication between the communication terminal and the base station does not exceed the above-mentioned data transmission speed. The actual transmission capacity determination section 243 records the actual transmission capacity in the actual transmission capacity memory section 222.

The transmission data flow control section 241 controls data reception by the reception section 231 from the communication terminal by instructing reception permission/prohibition to the transmission/reception control section 233 on the basis of the actual transmission capacity stored in the actual transmission capacity memory section 222 and the capacity of data to be transmitted to the base station.

The data communication control section 245 executes communication controls such as a communication start and a communication end, on the basis of signals from the transmission/reception control section 233, key input section 251 and radio reception section 212.

The transmission/reception data storage section 246 temporarily stores data received from the communication terminal via the reception section 231, and data received from the base station via the radio reception section 212.

The operation of the mobile radio terminal apparatus with the above structure will now be described. Assume that a personal computer as a communication terminal is connected to the terminal communication circuit 230. In this operation, application software for facsimile transmission is executed on the personal computer to transmit facsimile data to a facsimile connected to a public network.

FIGS. 5 and 6 are flow charts illustrating the operation, and the process in the flow charts is executed by the control circuit 240.

The user activates the application software on the personal computer and starts facsimile data transmission. If a signal requesting facsimile data transmission is input from the personal computer, the transmission speed information acquisition section 244 acquires information on the speed of data transmission between the base station and the other communication party and records this information in the transmission speed information memory section 223 (step 5a). This information on the data transmission speed is preset by the data communication control section 245 via the key input section 251, via the reception section 231 from the communication terminal, or via the radio reception section 212 from the base station. The control goes to step 5b.

In step 5b, the data communication control section 245 reads the data transmission speed set in step 5a out of the transmission speed information memory section 223 via the transmission speed information acquisition section 244. Based on the data transmission speed, a facsimile data transmission process is started, and a radio communication link is established between the radio circuit 210 and the base station. The control then goes to step 5c.

In step 5c, a data communication link with the base station is established via the radio communication link established in step 5b.

In step 5d, the transmissible capacity acquisition section 242 acquires a value of a receivable capacity from a reception signal received by the radio reception section 212 from the base station, and records the value in the transmissible capacity memory section 221 as a transmissible capacity. The control goes to step 5e.

In step 5e, the actual transmission capacity determination section 243 determines an actual transmission capacity on the basis of the transmissible capacity stored in the transmissible capacity memory section 221 and the data transmission speed stored in the transmission speed information memory section 223. The actual transmission capacity is indicative of a transmission capacity for communication, with which the average speed of communication between the personal computer and the base station does not exceed the above-mentioned data transmission speed. The actual transmission capacity determination section 243 records the actual transmission capacity in the actual transmission capacity memory section 222. The controls go to stop 5f.

In step 5f, prescribed communication is made between the personal computer and the facsimile that is the other party of communication. Then, the reception section 231 starts receiving facsimile data from the personal computer. The control goes to step 5g.

In step 5g, the data communication control section 245 determines whether a facsimile transmission end signal has been received from the personal computer via the reception section 231 or the transmission/reception control section 233, or from the key input section 251, or from the base station via the radio reception section 212.

If the data communication control section 245 determines that the facsimile transmission end signal has been received, a predetermined finish process is executed (step 5h) between the radio transmission section 211 and radio reception section 212, on the one hand, and the facsimile, on the other, Thus, the communication link is disconnected and the facsimile transmission is finished.

On the other hand, if the data communication control section 245 determines that the facsimile transmission end signal has not been received, the control goes to step 5i.

In step 5i, it is determined whether the transmission data flow control section 241 has issued a data transmission permission instruction to the transmission/reception control section 233 and the facsimile data received from the personal computer is stored in a reception buffer of the reception section 231.

If it has been determined in step 5i that the transmission data flow control section 241 has issued a data transmission permission instruction to the transmission/reception control section 233 and the facsimile data received from the personal computer is stored in the reception buffer of the reception section 231, the control advances to step 5j. Otherwise, the control advances to step 5k.

In step 5j, the facsimile data in the reception buffer of the reception section 231 is transferred to a transmission buffer of the transmission/reception data storage section 246, and the control goes to step 5k.

In step 5k, it is determined whether the transmission data flow control section 241 has issued the data transmission permission instruction to the transmission/reception control section 233.

In step 5k, if the transmission data flow control section 241 has issued the data transmission permission instruction to the transmission/reception control section 233, the control goes to step 51. If the transmission data flow control section 241 has not issued the data transmission permission instruction to the transmission/reception control section 233, the control goes to step 5p.

In step 51, the transmission data flow control section 241 determines whether the transmission buffer in the transmission/reception data storage section 246 contains facsimile data which has not yet been transmitted.

If the transmission data flow control section 241 has determined that the transmission buffer in the transmission/reception data storage section 246 contains non-transmitted facsimile data, the control goes to step 5m. Otherwise, the control goes to step 6a.

In step 5m, the actual transmission capacity determination section 243 compares the amount of non-transmitted facsimile data in the transmission buffer of the transmission/reception data storage section 246 with the actual transmission capacity stored in the actual transmission capacity memory section 222, and determines whether the amount of non-transmitted facsimile data is not greater than the actual transmission capacity.

If the actual transmission capacity determination section 243 determines that the amount of non-transmitted facsimile data is not greater than the actual transmission capacity, the control advances to step 5n. On the other hand, if the actual transmission capacity determination section 243 determines that the amount of non-transmitted facsimile data is greater than the actual transmission capacity, the control advances to step 5o.

In step 5n, the data communication control section 245 starts a process to transmit the non-transmitted facsimile data in the transmission buffer of the transmission/reception data storage section 246 to the facsimile from the radio transmission section 211 via the base station. The control then goes to step 6a.

In step 5o, the radio transmission section 211 starts a process to transmit the non-transmitted facsimile data in the transmission buffer of the transmission/reception data storage section 246 to the facsimile via the base station. In addition, the transmission data flow control section 241 issues a data transmission prohibition instruction to the transmission/reception control section 233. Thereby, the transmission/reception control section 233 informs the personal computer of prohibition of facsimile data transmission and stops reception of facsimile data from the reception section 231. Thus, the control goes to step 6a.

On the other hand, in step 5p, the transmission data flow control section 241 determines whether the transmission buffer in the transmission/reception data storage section 246 contains facsimile data which has not yet been transmitted.

If the transmission data flow control section 241 has determined that the transmission buffer in the transmission/reception data storage section 246 contains non-transmitted facsimile data, the control goes to step 5q. Otherwise, the control goes to step 5r.

In step 5q, the data communication control section 245 starts a process to transmit the non-transmitted facsimile data in the transmission buffer of the transmission/reception data storage section 246 to the facsimile from the radio transmission section 211 via the base station. The control then goes to step 6a.

In step 5r, in order to acquire information indicative of a receivable capacity from the base station via the radio reception section 212, the data communication control section 245 issues to the radio transmission section 211 an instruction to transmit dummy data containing no facsimile data. Responding to the instruction, the radio transmission section 211 transmits the dummy data to the base station, and the control goes to step 6a.

In step 6a, the transmissible capacity acquisition section 242 monitors the reception signal received by the radio reception section 212, and determines whether data indicative of the receivable capacity has been received from the base station.

If the transmissible capacity acquisition section 242 has determined that the data indicative of the receivable capacity was received, the control advances to step 6b. If the transmissible capacity acquisition section 242 has determined that the data indicative of the receivable capacity was not received, the control advances to step 5g.

In step 6b, the transmissible capacity acquisition section 242 acquires a value of the receivable capacity from the reception signal received by the radio reception section 212 from the base station, and records the value in the transmissible capacity memory section 221 as a transmissible capacity. The control goes to step 6c.

In step 6c, in order to update the actual transmission capacity, the actual transmission capacity determination section 243 determines an actual transmission capacity on the basis of the transmissible capacity stored in the transmissible capacity memory section 221 and the data transmission speed stored in the transmission speed information memory section 223. The actual transmission capacity is indicative of a transmission capacity for communication, with which the average speed of communication between the communication terminal and the base station does not exceed the above-mentioned data transmission speed. The control then advances to step 6d.

In stop 6d, the actual transmission capacity determination section 243 updates the actual transmission capacity in the actual transmission capacity memory section 222 and records therein the actual transmission capacity newly found in step 6c. The control advances to step 6e.

In step 6e, it is determined whether the transmission data flow control section 241 has issued a data transmission permission instruction to the transmission/reception control section 233.

If it is determined that the transmission data flow control section 241 has issued the data transmission permission instruction to the transmission/reception control section 233, the control goes to step 5g. On the other hand, if it is determined that the transmission data flow control section 241 has issued a data transmission prohibition instruction to the transmission/reception control section 233, the control goes to step 6f.

In step 6f, the actual transmission capacity determination section 243 determines whether the value of the actual transmission capacity newly found in step 6c is greater than 0, that is, whether the transmission of facsimile data can be transmitted to the base station.

If the actual transmission capacity determination section 243 has determined that the value of the actual transmission capacity newly found in step 6c is greater than 0, the control goes to step 6g. If the value of the actual transmission capacity is not greater than 0, the control goes to step 5g.

In step 6g, the transmission data flow control section 241 issues a data transmission permission instruction to the transmission/reception control section 233, and the control goes to step 5g.

As has been described above, in the mobile radio terminal apparatus with the above structure, an actual transmission capacity is determined on the basis of the receivable capacity acquired from the base station and the data transmission speed indicative of the communication speed on the network. The actual transmission capacity is indicative of a transmission capacity for communication from the mobile radio terminal apparatus to the base station, with which the average speed of communication between the communication terminal (personal computer) and the base station via the mobile radio terminal apparatus does not exceed the above-mentioned data transmission speed.

This actual transmission capacity is compared with the amount of data (facsimile data) that has not yet been transmitted and remains in the mobile radio terminal apparatus. If the amount of data is greater than the actual transmission capacity, the data input from the communication terminal is limited.

In short, the input of data from the communication terminal is controlled based on the receivable capacity reported from the base station and the data transmission speed indicative of the communication speed on the network.

According to the mobile radio terminal apparatus with the above structure, even if a data transmission control is effected between the mobile radio terminal apparatus and the base station in order to prevent overflow of data on the base station side, the reception of data from the communication terminal can be controlled so as to prevent time-out of the communication terminal. Therefore, even when much time has been consumed for data transmission with the base station, it is possible to prevent suspension of communication by the communication terminal and ensure smooth data transmission.

In the mobile radio terminal apparatus with the above structure, even when the data reception from the communication terminal is not permitted, the receivable capacity can be found prior to the data reception from the communication terminal (see step 6b), and the actual transmission capacity is determined (see step 6c).

According to the mobile radio terminal apparatus with the above structure, the receivable capacity is found prior to the data reception from the communication terminal. Thus, the determination as to the data reception can be effected in a more suitable manner for the actual situation. Moreover, since the actual transmission amount is updated following the reception or the information on the receivable capacity from the base station, exact and smooth data transmission can be performed.

The present invention is not limited to the above embodiments.

Needless to say, the present invention can be carried out, with various modifications being made without departing from the spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio terminal apparatus comprising;
first communication means for communicating with a communication terminal capable of transmitting data;
data storage means for temporarily storing the data received from the communication terminal via the first communication means;
second communication means for radio communicating with a base station connectable to a communication network;
detection means for detecting receivable capacity information indicative of a receivable data capacity of the base station, on the basis of a signal received from the base station via the second communication means; and
control means for controlling the first communication means, thereby controlling data reception from the communication terminal, on the basis of the receivable capacity information detected by the detection means and a communication speed on the communication network.

2. The mobile radio terminal apparatus according to claim 1, wherein said control means controls the second communication means on the basis of the receivable capacity information detected by the detection means, thereby executing a control to transmit the data stored in the data storage means to the base station.

3. The mobile radio terminal apparatus according to claim 1 or 2, wherein said control means includes:
actual transmission capacity determination means for determining an actual transmissible capacity on the basis of the receivable capacity information detected by the detection means and the communication speed on the communication network, and
said control means compares the actual transmissible capacity determined by the actual transmission capacity determination means with a capacity of the data stored in the data storage means, and controls the first communication means on the basis of a comparison result, thereby controlling data reception from the communication terminal.

4. A data transfer method for radio-communicating with a base station connectable to a communication network and transferring data received from a communication terminal capable of transmitting data to the communication network by means of the radio communication, the method comprising:
a data storing step of temporarily storing the data received from the communication terminal;
a capacity receiving step of receiving, from the base station, receivable capacity information indicative of a receivable data capacity of the base station; and
reception control step of controlling data reception from the communication terminal on the basis of the receivable capacity information received in the capacity receiving step and a communication speed on the communication network.

5. The data transfer method according to claim 4, wherein said reception control step controls radio communication with the base station on the basis of the receivable capacity information received in the capacity receiving step, and transmitting the data stored in the data storing step to the base station.

6. The data transfer method according to claim 4 or 5, wherein said reception control step includes:
an actual transmission capacity determination step of determining an actual transmissible capacity on the basis of the receivable capacity information detected in the capacity receiving step and the communication speed on the communication network, and
said reception control step compares the actual transmissible capacity determined in the actual transmission capacity determination step with a capacity of the data stored in the data storing step, and controls data reception from the communication terminal on the basis of a comparison result.

7. A mobile radio terminal apparatus comprising:
first communication means for communication with a communication terminal capable of transmitting data;
data storage means for temporarily storing the data received from the communication terminal via the first communication means;
second communication means for radio communication with a base station connectable to a communication network;
detection means for detecting receivable capacity information indicative of a receivable data capacity of the base station, on the basis of a signal received from the base station via the second communication means;
reception control means for controlling the first communication means, thereby controlling data reception from the communication terminal, on the basis of the receivable capacity information detected by the detection means and a communication speed on the communication network; and
detection control means for controlling the detection means prior to the control of the reception control means and
causing the detection means to detect new receivable capacity information.

8. The mobile radio terminal apparatus according to claim 7, wherein said reception control means controls the second communication means on the basis of the receivable capacity information detected by the detection means, thereby executing a control to transmit the data stored in the data storage means to the base station.

9. The mobile radio terminal apparatus according to claim 7 or 8, wherein said reception control means includes:
actual transmission capacity determination means for determining an actual transmissible capacity on the basis of the receivable capacity information detected by the detection means and the communication speed on the communication network, and
said control means compares the actual transmissible capacity determined by the actual transmission capacity determination means with a capacity of the data stored in the data storage means, and controls the first communication means on the basis of a comparison result, thereby controlling data reception from the communication terminal.

10. A data transfer method for radio-communicating with a base station connectable to a communication network and transferring data received from a communication terminal capable of transmitting data to the communication network by means of the radio communication, the method comprising:
a data storing step of temporarily storing the data received from the communication terminal;
a capacity receiving step of receiving, from the base station, receivable capacity information indicative of a receivable data capacity of the base station;
a reception control step of controlling data reception from the communication terminal on the basis of the receivable capacity information received in the capacity receiving step and a communication speed on the communication network; and
a detection control step of executing the capacity receiving step prior to the reception control step and detecting new receivable capacity information.

11. The data transfer method according to claim 10, wherein said reception control step controls radio communication with the base station on the basis of the receivable capacity information received in the capacity receiving step, and transmitting the data stored in the data storing step to the base station.

12. The data transfer method according to claim 10 or 11, wherein said reception control step includes:
an actual transmission capacity determination step of determining an actual transmissible capacity, prior to the control of data reception from the communication terminal, on the basis of the receivable capacity information detected in the capacity receiving step and the communication speed on the communication network, and
said reception control step compares the actual transmissible capacity determined in the actual transmission capacity determination step with a capacity of the data stored in the data storing step, and controls data reception from the communication terminal on the basis of a comparison result.
